(19) United States
(12) Patent Application Publication
(10) Pub. No.: US 2008/0133365 A1
(43) Pub. Date: Jun. 5, 2008

(54) Targeted Marketing System

(76) Inventors: Benjamin Sprecher, Providence, RI (US); Joshua Herzig-Marx, Newton Highlands, MA (US)

Correspondence Address: CHOATE, HALL & STEWART LLP, TWO INTERNATIONAL PLACE, BOSTON, MA, 02110, US

(21) Appl. No.: 11/937,112

(22) Filed: Nov. 8, 2007

Related U.S. Application Data
(60) Provisional application No. 60/860,414, filed on Nov. 21, 2006.

(51) Int. Cl. G06Q 30/00

(52) U.S. Cl. 705/14

(57) ABSTRACT

Targeted marketing system. A marketing portal is provided to create and maintain offer campaigns having specific consumer targeting rules. An offer optimization module determines specific offers for each eligible consumer, the offers are distributed to specific consumers through one or more distribution channels, and the system is updated with information about the offers distributed and the consumers reached. A point of sale checkout system processes the offer and a tracking module reconciles a list of issued offers with successful redemptions.

This application claims priority to Provisional Application Serial No. 60/860,414 filed Nov. 21, 2006, the contents of which are incorporated herein by reference.

### BACKGROUND OF THE INVENTION

Coupons are big business. U.S. Marketers spent more than $7 billion on coupons in 2005 alone.¹ (Superscript numbers refer to the references included herewith. The contents of all of these references are incorporated herein by reference.) Yet of the 300 billion or so coupons distributed, consumers redeem only about 1%, and the rate is falling.² Even “targeted” methods of distribution, such as on-shelf coupon distributors and Point-of-Sale (POS) coupon printing systems, only achieve 7% redemption Rates.³ At the same time, grocery loyalty cards are the most frequently used discount method,⁴ have high perceived customer value,⁵ and tie directly to the best possible source of targeting date—the customer's past purchase history. Unfortunately for manufacturers, there is no good way today to leverage that data to target the individual customer at the moment of purchase decision.

Problems with existing coupon systems are not limited to low redemption rates. The individuals most likely to clip, organize, save, and redeem coupons tend to be the least desirable customers. Because of inefficiencies in distribution and long planning cycles, manufacturers issue coupons that are valid for weeks or months, complicating coordination with retailers and leading to unpredictable costs. And once redeemed, coupons require costly, time-consuming, and error- and fraud-prone processing using the coupon clearinghouse system.

Shopper loyalty cards also have not lived up to their promise. Despite widespread adoption,⁶ they often end up acting as a front for retailers' traditional discounting activities without fostering true loyalty.⁷ At the same time, manufacturers miss the significant value that the purchase history data represents, as they cannot use it to selectively target customers. This represents a tremendous missed opportunity, as 85% of shoppers are interested in receiving personalized promotions while they shop.⁸

### SUMMARY OF THE INVENTION

In one aspect, the targeted marketing system of the invention includes a marketing portal to create and maintain offer campaigns having specific consumer targeting rules. An offer optimization module determines specific offers for each eligible consumer. The offers are distributed to specific consumers through one or more distribution channels, with each consumer receiving only the offers for which they have been selected. Each offer distribution updates the system with information about the offers distributed and the consumers reached. A point of sale checkout system processes the offer and a tracking module reconciles a list of issued offers with successful redemptions.

The offer distribution channels may include direct mail, email, printing by the point of sale checkout system, mobile phone text messages or any other means of communicating the substance of a marketing message or coupon directly to a specific consumer. In one embodiment, at least one automated terminal located in a retail establishment dispenses one or more targeted marketing messages in a physical form to an identified consumer. These enumerated channels are exemplary only and other channels may be utilized.

In a preferred embodiment, the consumer targeting rules are based on a consumer's purchase history or are based on known attributes of the consumer. Such attributes include income, age, place of residence, household size, or pet ownership. These enumerated attributes are exemplary only and other attributes may be utilized.

In another preferred embodiment, the targeting rules specify which retail chains, regions or specific stores may participate in the offer campaign. With respect to offers to be issued, marketers can designate campaign budgets, time periods and caps on the number or value of offers to be issued. In one embodiment, the offer optimization module uses the targeting rules to eliminate offers for which a consumer is not eligible. It is preferred that the offer optimization module determine an optimal mix of offers based on selected factors that include likelihood of redemption, value of the offer to the consumer and the price that a manufacturer will pay per dispensed and redeemed offer.

It is preferred that the targeted marketing message include coupons, information about loyalty reward points, advertisements, or sweepstakes information. In another preferred embodiment, the targeted marketing message may be used to communicate non-promotional information to specific consumers, such as informing all consumers who have purchased a recalled product about the recall, or providing any other information that a user of the system may wish to communicate to a targeted subset of consumers.

In preferred embodiments, the offers expire after a selected time and include standard UPC bar codes. It is also preferred that the offers be labeled with a specific customer identification. Yet a further embodiment includes a marketing analytics module allowing determination of precise qualities of consumers who did and did not redeem offers.

### BRIEF DESCRIPTION OF THE DRAWING

FIG. 1 is a block diagram illustrating an embodiment of the invention.

### DESCRIPTION OF THE PREFERRED EMBODIMENT

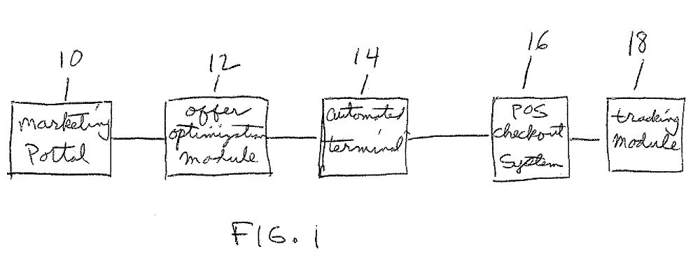

With reference now to FIG. 1, marketers access the system of the invention through a marketing portal 10, such as, for example, a web portal or other user interface, to create and maintain offer campaigns with specific consumer targeting rules. These rules can be based on the purchase history or any other known (or inferred) attributes of a particular consumer (such as income, age, place of residence, household size, pet ownership, etc.). The targeting rules can also specify which retail chains, regions or specific stores can participate in the campaign. Marketers can designate campaign budgets, time periods, and caps on the number or value of offers to be issued. The system provides interactive tools to assist marketers in designing their campaigns, forecasting campaign costs and effectiveness, projecting increased demand, and communicating with retailers about upcoming and ongoing campaigns. The system of the invention also makes provision for purely informational campaigns (such as loyalty reward point updates, advance notice of upcoming sales, or alerts of product recalls).

Pricing may be performance based. That is, marketers pay based on their targeted offer campaigns' effectiveness. For each campaign, marketers set the amount they will pay for each redeemed offer. An additional fee based on the number of coupons issued, or some other factor, can optionally be applied, Because the marketer is paying for offers that actually tie to a sale of the product, they can afford to pay much more per offer than they would for traditional coupon distribution methods. This pricing mechanism ensures that campaigns are very low risk for marketers while maximizing the potential revenue for the targeted marketing system of the invention.

Still referring to FIG. 1, an offer optimization module 12 determines the specific offers to issue for each consumer. The system 12 uses the campaign targeting rules to eliminate offers for which the consumer is not eligible. This system 12 then determines the optimal mix of offers to display based on such factors as the estimated likelihood of redemption, the value of the offer to the consumer, and the price that the manufacturer will pay per dispensed and redeemed offer. The module 12 will typically be configured to favor offers with high per-redemption fees, high face values, and a high estimated likelihood of being redeemed. By continuously refining the mix of offers, the system guarantees the highest possible value for the consumer and the greatest revenues for the system disclosed herein.

Those of ordinary skill in the art will recognize that retailers access the system to learn about upcoming and ongoing campaigns in order to improve inventory management, reduce out-of-stocks, and to suspend or opt out of particular campaigns. Automatic alerts can inform retailers when they need to increase inventory ahead of a large campaign. It is contemplated that the system disclosed herein can also inform retailers when coupon redemption patterns indicate that there is a problem at one or more of the stores. Additionally, retailers can create and issue their own offer campaigns using the same tools available to marketers.

In one embodiment, at least one automated terminal or kiosk 14 serves as the offer distribution channel and is placed near the entrance of a retail store or in some other high-traffic areas. Consumers approach the automated terminal or kiosk 14, identify themselves by scanning their shopper loyalty card, and receive targeted marketing messages as a printed sheet or in some other physical or electronic form. These messages include high-value coupons, information about loyalty rewards points, advertisements, sweepstakes information, and any other message or offer. The kiosk 14 is designed to minimize user interaction time and inconvenience. Following a consumer interaction, the kiosk updates the overall system with information about the customer interaction, including any offers issued.

The offers delivered to a customer are selected by the offer optimization module 12. The offers can be set to expire on the day issued or within a specified number of hours or days. Coupons are preferably printed with standard coupon UPC bar codes so that redemption at a checkout terminal 16 requires no modification to existing POS systems, It is preferred that each offer be labeled with a customer identification and unique offer identifiers to prevent fraud and to facilitate auditing and reconciling redeemed offers.

The targeted marketing system of the invention does not require any disruption to a retailer's POS checkout system. By using standard UPC coupon and value codes, the offers will work like normal manufacturer's coupons. If desired, the system may be configured to require a consumer to scan his or her loyalty card or provide other identification to ensure that the consumer is redeeming only offers that were issued to them. In situations in which a retailer wishes to integrate its POS system with the targeted marketing system of the invention, the offer list can be transmitted to the POS system and tied to the consumer's loyalty card, thereby eliminating the need to scan any coupons at checkout. The linking of the offer list to a consumer's loyalty card is not required to gain full value from the system disclosed herein.

If desired, individual retailers may update the targeted marketing system disclosed herein with loyalty purchase and offer redemption data from their back-office system. Updates can take place nightly, continuously, or at any interval the retailer chooses. The data are transmitted to the targeted marketing system, associated with the appropriate consumers, and used to update targeting rules and campaign effectiveness metrics.

Still referring to FIG. 1, offer redemptions are tracked in a tracking module 18 by reconciling the list of offers issued against the specific purchase history of each consumer. Whenever a consumer receives an offer and purchases a product during the offer period, the system determines that a successful redemption occurred. Since this determination can take place electronically, retailers and manufacturers can avoid the time, errors, and expense of manually processing redeemed coupons or sending them through a clearinghouse. The calculated redemption numbers are then used to determine payments owed by manufacturers and to the company.

Those of skill in the art will recognize that the present system's precise offer targeting and redemption tracking allows detailed marketing analytics for manufacturers and retailers. Manufacturers can access these interactive analytics through the marketing portal 10. Through a combination of charts, graphs, executive dashboards, statistical analysis, and detailed, drill-down analytics, a marketer can determine the precise qualities of the individuals who did and did not redeem offers, as well as observing patterns of purchasing behavior in each group, both before and after a campaign. This level of detail enables insight into the “conversion” process of individuals into repeat customers. Analytical findings can be used to hone ongoing or future campaigns, refine targeting criteria, identify new potential customers and markets, and to drive marketing decisions and other media.

Variable per-redemption pricing of the present system allows bidding by manufacturers for the most desirable offer deliveries. Low or zero fees per issued offer means marketers bear little risk. Dynamic optimization of the offer mix maximizes value to the consumer while producing the highest expected value for fees from manufacturers (based on expected redemption likelihood and the fee per redemption). The use of standard UPC coupon codes allows for non-disruptive, low-risk installations at retailers. Additional integration can be performed to improve efficiency but is not necessary for the system to deliver value. The kiosks disclosed herein are designed for minimal interaction and thereby encourage habitual system usage by customers. It is preferred that automated and manual alerts and messages be utilized to improve coordination between retailers and manufacturers so as to avoid out-of-stock situations and to maximize revenues. Advanced analytics before, during, and after campaigns provides valuable insight for marketers and retailers.

The system disclosed herein can be modified and extended in various ways to enhance the value of the system. For example, reserved “slots” may be provided in the offer mix for retailers (for loyalty point information, sale updates, store brand promotion, etc.). Profit/revenue sharing with retailers is also contemplated. It should be recognized that consumer identification at a kiosk can be made by credit card swipe, RFID, biometric (fingerprint, iris scan, voice print, etc.), PIN, loyalty card scan, cell phone, or any other means, It is preferable that consumer identification be as quick and non-disruptive as possible.

The present invention can provide automatic creation of “experimental” campaigns by varying offer design between similar geographies, chains, stores or individuals. Control groups can be manually or automatically excluded from receiving offers for which they qualify so as to allow for comparative analysis against the rest of the targeted individuals. Campaigns can also vary coupon values to determine price sensitivity of consumers. Further, nonspecific coupons offering a percentage discount from a consumer's entire order can be issued to ensure high perceived value and to encourage customers to hold onto an offer until checkout. It is also contemplated that customers print coupons from home and enter additional personal information to improve targeting. For example, a consumer might fill out a questionnaire for a guaranteed additional savings on a next visit.

The system of the invention can be used in any retail environment such as, merely by way of example, grocery stores, pet supply stores, general retailers, and department stores. Other types of retailers, as well as online retailers, can use variations of the present system.

Customer data should be anonymized before marketers are given access. Data sets visible to marketers can be masked so as to include only information about the product being promoted and direct competitors, or to only include aggregate information. Automated integration with a store's inventory system can allow the system of the invention to stop issuing offers when inventory gets too low, to automatically order more from a manufacturer based on upcoming campaigns, and to refine inventory management even when campaigns are not in progress. Automated regression analysis can be run to provide high value indicators that may impact campaign effectiveness or general buying patterns. This list of enhancements is meant to be representative only. Many additional variations are possible that will add value without undermining the fundamental innovation of the targeted marketing system disclosed herein.

### References

1. “Clipping Slows”, Promo Magazine, Apr. 1, 2006 (http://promomagazine.com/mag/marketing_clipping_slows/).

2. “Clipping Slows”

3. The Coupon Report: A Study of Coupon Discount Methods, Park, Kristen and Gómez, Miguel, Cornell University, March 2004, p. 4.

4. The Coupon Report: A Study of Coupon Discount Methods, pp. 10, 16.

5. Maximizing Grocery Loyalty Data, Overby, Christine Spivey, Forrester Research, Feb. 24, 2005, p.3.

6. Maximizing Grocery Loyalty Data, pp. 1-3.

7. What Drives Retail Consumer Loyalty?, Mendelsohn, Tamara, Forrester Research, Jun. 21, 2006, p. 3.

8. Smart Screens Boost Stop & Shop's Store Experience, Overby, Christine Spivey, Forrester Research, Sep. 12, 2003, p. 2.

What is claimed is:

1. Targeted marketing system comprising:
a marketing portal to create and maintain offer campaigns having specific consumer targeting rules;
an offer optimization module to determine specific offers (or no offer) for each eligible consumer;
at least one offer distribution channel to deliver the selected offers to the appropriate consumers, and to update the system with information about the offers distributed and the consumers reached;
a point of sale checkout system to process the offer; and
a tracking module for reconciling a list of issued offers with successful redemptions.

2. The system of claim 1 wherein the consumer targeting rules are based on a consumer's purchase history.

3. The system of claim 1 wherein the consumer targeting rules are based on known (or inferred) attributes of the consumer.

4. The system of claim 3 wherein the attributes include income, age, place of residence, household size or pet ownership.

5. The system of claim 1 wherein the targeting rules specify which retail chains, regions or specific stores may participate in the offer campaign.

6. The system of claim 1 wherein marketers can designate campaign budgets, time periods and caps on the number or value of offers to be issued.

7. The system of claim 1 wherein the offer optimization module uses the targeting rules to eliminate offers for which a consumer is not eligible.

8. The system of claim 1 wherein the offer optimization module determines an optimal mix of offers based on selected factors.

9. The system of claim 8 wherein the selected factors include likelihood of redemption, value of the offer to the consumer and the price that a manufacturer will pay per dispensed and redeemed offer.

10. The system of claim 1 wherein the targeted marketing message includes coupons, information about loyalty reward points, advertisements, sweepstakes information, or informational messages.

11. The system of claim 1 wherein the offers expire after a selected time.

12. The system of claim 1 wherein the offers include standard UPC bar codes.

13. The system of claim 12 wherein the offers are labeled with a specific customer identification.

14. The system of claim 1 further including a marketing analytics module allowing determination of qualities of consumers who did and did not redeem offers.

15. The system of claim 1 wherein the offer distribution channel includes an automated terminal located in a retail establishment.

16. The system of claim 15 wherein the consumer is identified through biometric information such as fingerprint, voice print, retinal scan, iris scan, or facial recognition.

17. The system of claim 15 wherein the consumer is identified through an RFID signal.

18. The system of claim 15 wherein the consumer is identified through a loyalty card or key fob encoded with a bar-code or magnetic stripe.

19. The system of claim 15 wherein the consumer is identified through a phone number, account number, name or other unique identifier or a personal identification number (PIN).

20. The system of claim 10 wherein the informational message is a product recall notice and the targeting rule is based on the prior purchase by the consumer of the recalled product.
